(19) United States
(12) Patent Application Publication
(10) Pub. No.: US 2026/0181362 A1
(43) Pub. Date: Jun. 25, 2026

(54) MECHANISM FOR UE ROLE AUTHORIZATION BASED ON ACCESS NETWORK

(71) Applicant: InterDigital Patent Holdings, Inc., Wilmington, DE (US)

(72) Inventors: Anuj SETHI, Ottawa (CA); Michael STARSINIC, Newtown, PA (US); Taimoor ABBAS, Sainte-Julie (CA); Saad AHMAD, Montreal (CA); Samir FERDI, Kirkland (CA); Jung Je SON, Warrington, PA (US)

(73) Assignee: InterDigital Patent Holdings, Inc., Wilmington, DE (US)

(21) Appl. No.: 18/989,778

(22) Filed: Dec. 20, 2024

(51) Int. Cl. H04W 4/50; H04W 12/06; H04W 36/24; H04W 48/16; H04W 84/04

(52) U.S. Cl. CPC H04W 4/50; H04W 12/06; H04W 36/24; H04W 48/16; H04W 84/042

(57) ABSTRACT

In some implementations, a method performed in a WTRU may include transmitting, to a wireless network, a WTRU policy provisioning request message, the message indicating WTRU role specific policies requested by the WTRU. The method may include receiving a WTRU policy command message including WTRU role specific policies associated with a respective access technology restriction. The method may include storing the WTRU role specific policies. The method may include transmitting a WTRU policy complete message. The method may include performing at least one procedure based on the stored WTRU role specific policies, the at least one procedure including: enabling a specific WTRU role, disabling a specific WTRU role, triggering cell selection or cell reselection to enable the specific WTRU role, or triggering a public land mobile network (PLMN) search for a PLMN that can support the WTRU role specific policies.

### BACKGROUND

National and international roaming services are essential for ensuring seamless connectivity, especially in areas where the primary or home network operator lacks coverage. A network selection is the process by which a user equipment (UE) or a wireless transmit/receive unit (WTRU) performs a radio scan to check the availability of the PLMNs at its current location and try to register to the PLMN. At switch on or following recovery from lack of coverage, a WTRU select select the PLMN that the WTRU last registered with (if it's available) using the last registered access technology and perform registration procedure. If the PLMN that the WTRU last registered with is not available, then the WTRU may scan all RF channels in all supported bands and access technologies according to its capabilities to find available PLMNs.

Allowing unrestricted use of radio access technologies (RAT) for roaming users can result in technical challenges including interoperability issues, quality of service concerns and network congestion concerns. Network and mobile operators may restrict a subscriber's (user's) access to certain RAT and reject the user's attempts to attach or register with a specific RAT. Existing mechanisms, however, may result in higher signal loads within the network, a service outage until the user selects another network or RAT, and the user device continuing re-attempts to access or register with the same PLMN and/or RAT. In addition, an indirect network connection may allow a UE/WTRU that is out of cellular coverage to connect to the network using another WTRU as a relay WTRU. For a 5G system with satellite access, the relay WTRU could access the network via satellite access. However, due to the low transmission rate and narrow transmission bandwidth of satellite access, when the relay WTRU is connected to the 5G network via satellite access, the user experience of the remote WTRU and relay WTRU may be affected.

From mobile operator viewpoint, in order to provide better user experience, the operator should be able to maintain control in authorizing the WTRU to perform certain services or enable use of certain capabilities or perform certain roles, for example to act as a relay UE/WTRU, Vehicle Mounted relay (VMR), UAV etc.) based on the access technology being used by the WTRU to access the network. Thus, the need exists for a technological solution that allow a mobile network operator to determine, maintain, and authorize how the UE/WTRU operates in the mobile network.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method performed by a wireless transmit/receive unit (WTRU) may include registering the WTRU with a wireless network. The method may also include transmitting, to the wireless network, a WTRU policy provisioning request message where the WTRU policy provisioning request message indicates WTRU role specific policies requested by the WTRU. The method may furthermore include receiving, from the wireless network, a WTRU policy command message where the WTRU policy command message includes WTRU role specific policies associated with a respective access technology restriction. The method may in addition include storing the WTRU role specific policies associated with the respective access technology restriction. The method may moreover include transmitting, to the wireless network, a WTRU policy complete message. The method may also include performing at least one procedure based on the stored WTRU role specific policies, the at least one procedure including: enabling a specific WTRU role, disabling a specific WTRU role, triggering cell selection or cell reselection to enable the specific WTRU role, or triggering a public land mobile network (PLMN) search for a PLMN that can support the WTRU role specific policies. Other embodiments of this aspect include corresponding computer systems, apparatus, and computer programs recorded on one or more computer storage devices, each configured to perform the actions of the methods.

Implementations may include one or more of the following features. The method where the WTRU specific role is one of operating as a WTRU-to-network relay or operating as a remote WTRU. The method may include: transmitting the WTRU policy provisioning request each time an access technology currently employed by a serving cell is changed, or transmitting the WTRU policy provisioning request in a case where no WTRU role specific policies are currently stored by the WTRU. The method where the WTRU specific role is operating as the WTRU-to-network relay and where the WTRU role specific policies include a list of access technologies where the WTRU is authorized to act as a ProSe layer-3 WTRU-to-network relay or a ProSe layer-2 WTRU-to-network relay. The method where triggering cell reselection is performed when the WTRU operating as the WTRU-to-network relay is not authorized to operate as the WTRU-to-network relay in an access technology currently employed by a serving cell. The method may include: searching for a new PLMN when the WTRU operating as the WTRU-to-network relay cannot find a cell where the WTRU is authorized to operate as a WTRU-to-network relay, where access technology restrictions are added to an existing list of PLMNs in which the WTRU operating as the WTRU-to-network relay is authorized to operate as the WTRU-to-network relay. The method may include: initiating a link release procedure to inform a remote WTRU that an authorization to operate as the WTRU-to-network relay is revoked or not allowed. The method where the WTRU specific role is to operate as the remote WTRU and the WTRU role specific policies include: a list of access technologies where one or more WTRU-to-network relays are authorized and a list of access technologies where one or more WTRU-to-network relays are not authorized, either alone or in combination, and where the list of access technologies where one or more WTRU-to-network relays are authorized includes a respective priority for each of the one or more WTRU-to-network relays that are authorized. The method may include selecting a relay WTRU based on the list access technologies where the one or more WTRU-to-network relays are authorized. Implementations of the described techniques may include hardware, a method or process, or a computer tangible medium.

In one general aspect, a wireless transmit/receive unit (WTRU) may include processor circuitry and a transceiver coupled to the processor circuitry and configured to: transmit, to a wireless network, a WTRU policy provisioning request message, the WTRU policy provisioning request message indicating WTRU role specific policies requested by the WTRU, where the WTRU is registered with the wireless network; and receive, from the wireless network, a WTRU policy command message, the WTRU policy command message including WTRU role specific policies associated with a respective access technology restriction. The processor circuitry may be configured to store the WTRU role specific policies associated with the respective access technology restriction. The transceiver may be configured to transmit, to the wireless network, a WTRU policy complete message, and the processor circuitry may be configured to perform at least one procedure to perform based on the stored WTRU role specific policies, the at least one procedure including: enabling a specific WTRU role, disabling a specific WTRU role, triggering cell selection or cell reselection to enable the specific WTRU role, or triggering a public land mobile network (PLMN) search for a PLMN that can support the WTRU role specific policies. Other embodiments of this aspect include corresponding computer systems, apparatus, and computer programs recorded on one or more computer storage devices, each configured to perform the actions of the methods.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of a simplified architecture model with a ProSe UE-to-Network relay;

FIG. 3 illustrates an example discovery and establishment procedure of a ProSe UE-to-Network relay;

FIG. 4 illustrates an example process of WTRU requested WTRU Role specific policy provisioning; and

FIG. 5 is a flow diagram of an example WTRU Role specific policy provisioning process.

### DETAILED DESCRIPTION

Abbreviations and Acronyms
AMF Access and Mobility Function
AF Application Function
CAG Closed Access Group
EHPLMN Equivalent Home PLMN
eHN equivalent Hosting Networks
FPLMN Forbidden PLMN
eSNPN equivalent SNPNs
GUI Graphical User Interface
GIN Group ID for Network Selection
HPLMN Home Public Land Mobile Network
IE Information Element
IMSI International Mobile Subscriber Identity
MCC Mobile Country Code
MNC Mobile Network Code
MS Mobile Station
NAS Non-Access Stratum
NG Next Generation
NPN Non-Public Network
NS Network Slicing
NSSAI Network Slice Selection Assistance Information
NSSAA Network Slice-Specific Authentication and Authorization
NWDAF Network Data Analytics Function
OPLMN Operator Controlled PLMN (Selector List)
PALS Providing Access to Localized Services
PLMN Public Land Mobile Network
PNI-NPN Public Network Integrated NPN
RA Registration Area
RAN Radio Access Network
RAT Radio Access Technology
RFSP RAT/Frequency Selection Priority
RPLMN Registered Public Land Mobile Network
S-NSSAI Single NSSAI
SIM Subscriber Identity Module
SoR Steering of Roaming
SoR-SNPN-SI-LS SoR SNPN Selection Information for Localized Services
TA Tracking Area
TAI TA Identity
UE User Equipment
SNPN Standalone NPN
UICC Universal Integrated Circuit Card
USIM UICC with SIM
VPLMN Visited Public Land Mobile Network

The following terminology is provided to ensure clarity throughout the description.

Access Technology: The access technology associated with a PLMN or SNPN. The MS uses this information to determine what type(s) of radio carrier to search for when attempting to select a specific PLMN or SNPN. The following access technologies are defined: GSM, UTRAN, GSM COMPACT, EC-GSM-IoT, cdma 2000 1xRTT, cdma 2000 HRPD, E-UTRAN (WB-S1 mode and NB-S1 mode), NG-RAN, satellite NG-RAN and satellite E-UTRAN (WB-S1 mode and NB-S1 mode). A PLMN may support more than one access technology. SNPNs only support NG-RAN.

Camped on a cell: The MS (ME if there is no SIM) has completed the cell selection/reselection process and has chosen a cell from which it plans to receive all available services. Note that the services may be limited, and that the PLMN or the SNPN may not be aware of the existence of the MS (ME) within the chosen cell.

Current serving cell: This is the cell on which the MS is camped.

Home PLMN: This is a PLMN where the MCC and MNC of the PLMN identity match the MCC and MNC of the IMSI.

Visited PLMN: This is a PLMN different from the HPLMN (if the EHPLMN list is not present or is empty) or different from an EHPLMN (if the EHPLMN list is present).

In S1 mode: Indicates this clause applies only to an EPS. The S1 mode includes WB-S1 mode and NB-S1 mode. For a multisystem case this is determined by the current serving radio access network.

In N 1 mode: Indicates this clause applies only to an 5GS. For multi system case this is determined by the current serving radio access network.

Registered PLMN (RPLMN): This is the PLMN on which certain LR outcomes have occurred. In a shared network the RPLMN is the PLMN defined by the PLMN identity of the CN operator that has accepted the LR.

Registration: This is the process of camping on a cell of the PLMN or the SNPN and doing any necessary LRs.

Selected PLMN: This is the PLMN that has been selected, either manually or automatically.

Source Layer-2 ID: A link-layer identity that identifies a device that originates ProSe communication frames.

Destination Layer-2 ID: A link-layer identity that identifies a device or a group of devices that are recipients of ProSe communication frames.

ProSe UE-to-Network Relay: A UE/WTRU that provides functionality to support connectivity to the network for Remote UE/WTRU(s).

Remote UE/WTRU: A ProSe-enabled Public Safety UE/WTRU that communicates with a PDN via a ProSe UE-to-Network Relay.

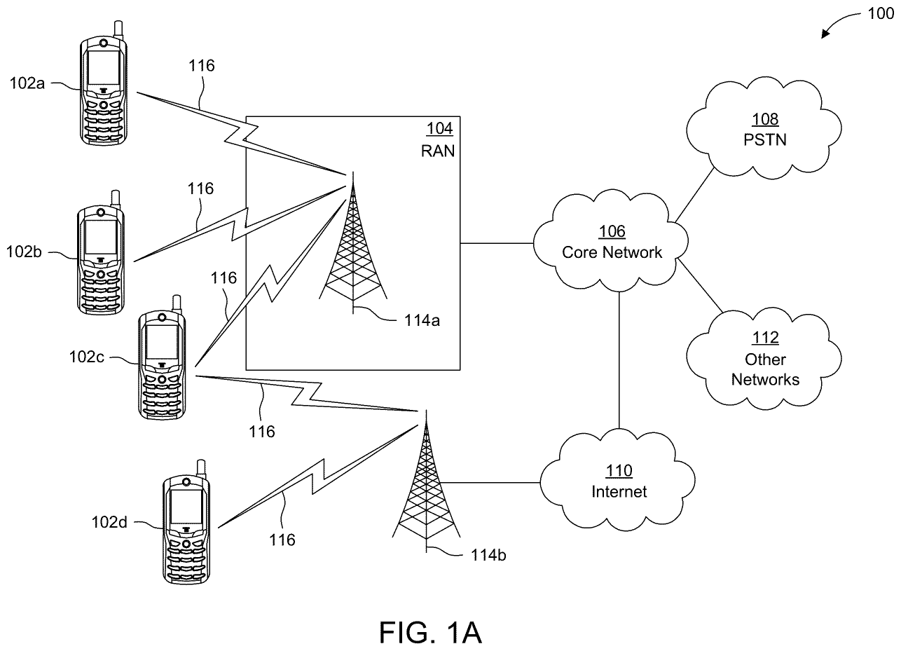

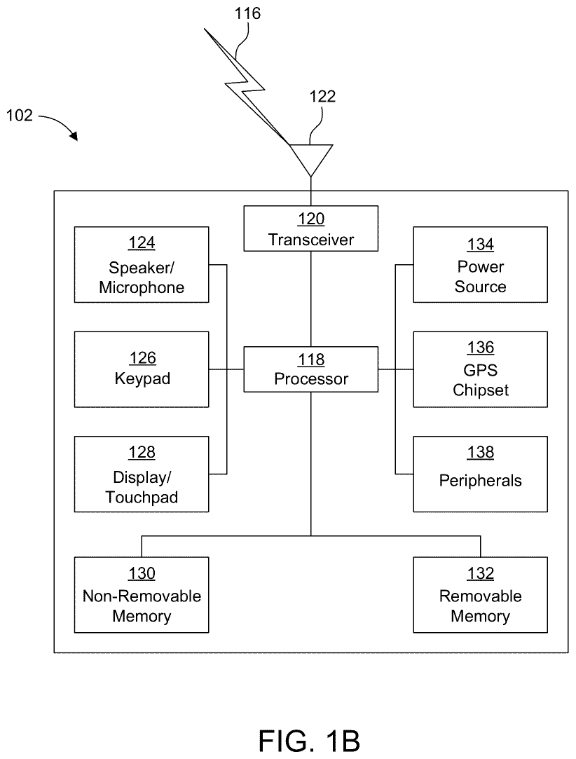

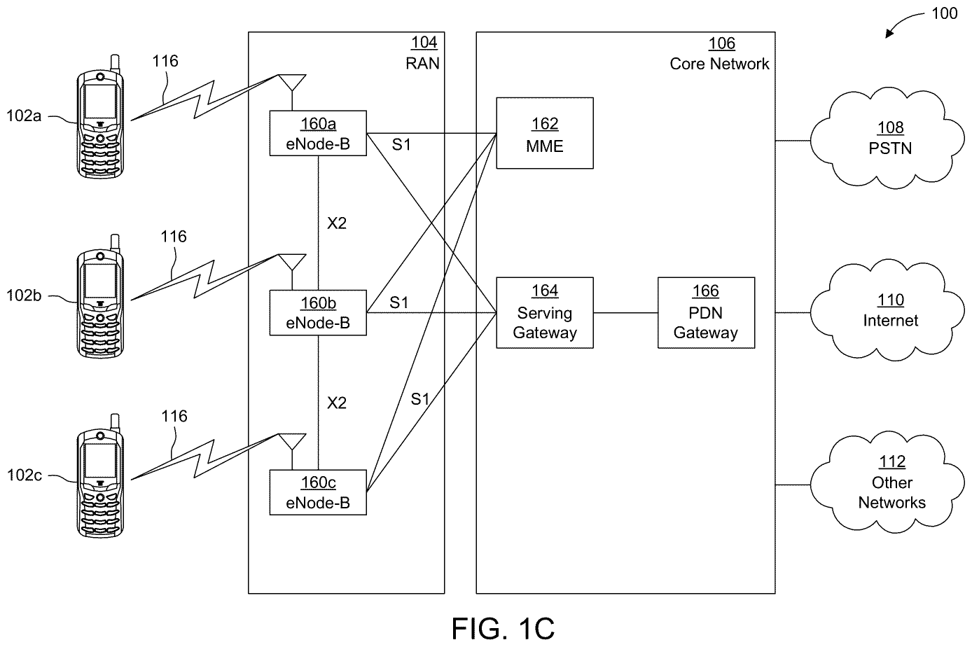

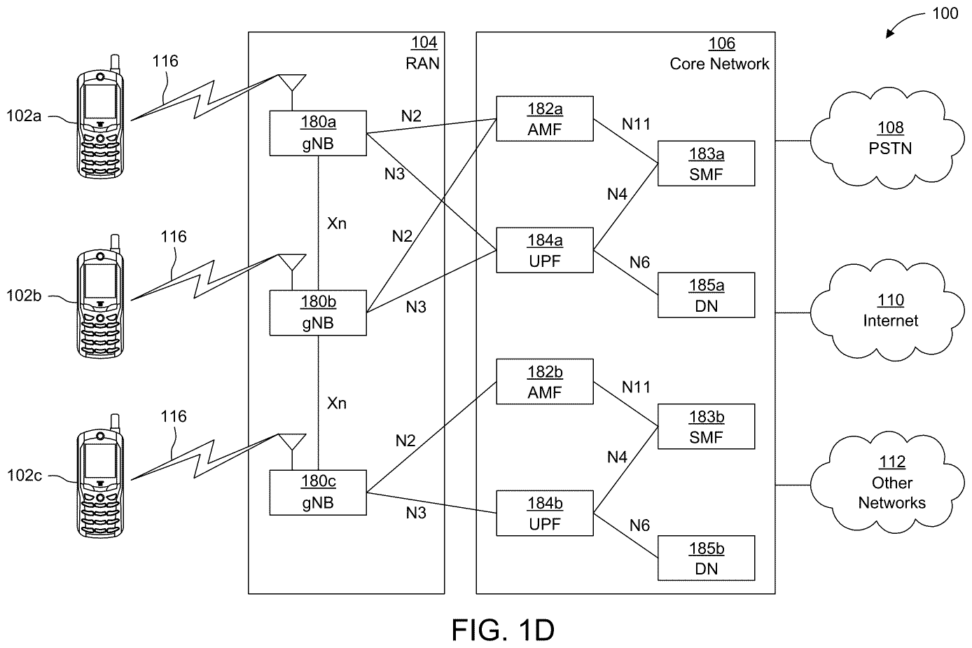

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102 d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S 1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN. A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

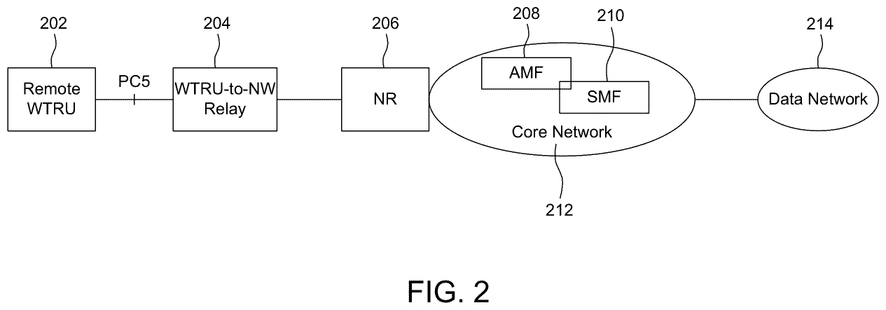

FIG. 2 illustrates an example architecture model with a ProSe UE-to-Network relay. Remote WTRU 202 may be at a cell edge or out of coverage. Remote WTRU 202 may establish a sidelink or a PC5 link with a WTRU 204 that acts as a WTRU-to-network relay. WTRU-to-network relay 204 may have a wireless connection to the wireless network via a NR gNB 206. The core network 212 may include an AMF 208 and a SMF 210. Core network 212 may include connectivity with a data network 214.

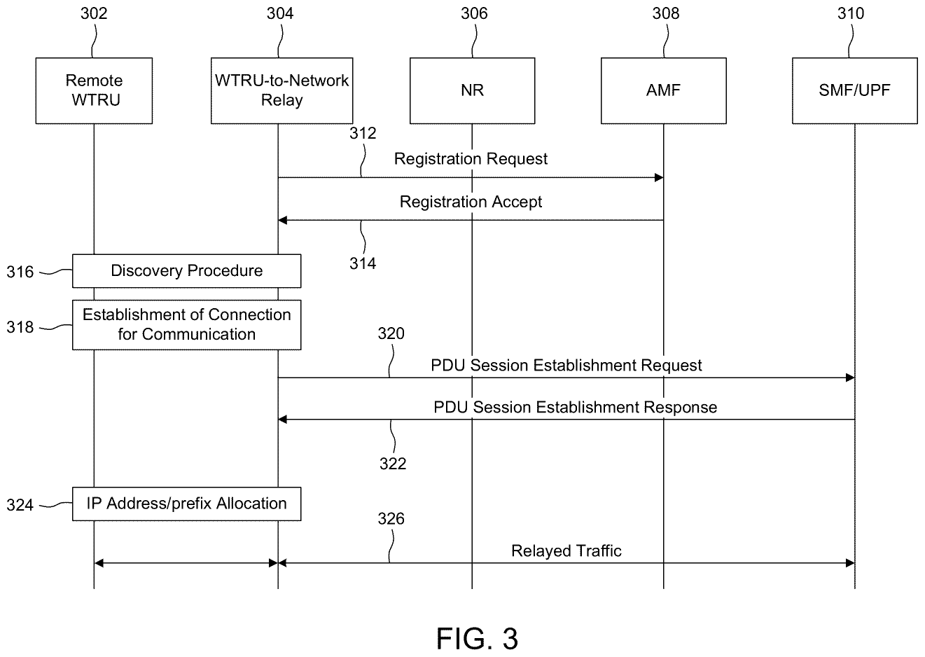

FIG. 3 illustrates an example discovery and establishment procedure of a ProSe UE-to-Network relay. A WTRU-to-Network relay, WTRU 304, sends an establishment request at 312. The establishment request is sent to AMF 308 via NR 306 which may be a gNB. At 314, WTRU 304 receives a registration accept message from AMF 308 via NR 306. WTRU 304 may broadcast information indicating its role as a WTRU-to-Network relay. At 316, remote WTRU 302 may a discovery procedure to find a WTRU-to-Network relay. The discovery procedure may also be used to select another WTRU relay. Remote WTRU 302 and WTRU 304 establish a connection for communication at 318. This connection may be a PC5 session. WTRU 304 may send a PDU session establishment request to SMF/UPF 310 at 320. Alternatively, a PDN connection may be established in EPC. At 322, SMF/UPF 310 sends a PDU session establishment response to WTRU 304. An IP address/prefix allocation is established at 324, and at 326, traffic to and from remote WTRU 302 may be relayed by WTRU 304.

A WTRU may requested WTRU role specific policy provisioning. The WTRU may perform a procedure that includes the following. The WTRU requested WTRU Role specific policy provisioning procedure is initiated by the WTRU to request WTRU Role Policy/Parameter from the PCF under following conditions: the WTRU does not have any valid WTRU Role Specific policies. (Initial registration/power up scenario, WTRU Role has been enabled by the higher lawyers etc.), and the WTRU Role policies have a parameter indicating that at every change of access technology, the WTRU may request new set of policies from the 5GS (e.g. PCF).

In order to initiate the WTRU requested WTRU Role specific policy provisioning procedure, the WTRU may create a UE POLICY PROVISIONING REQUEST message, including the requested WTRU role specific policies (e.g., 5G ProSe UE-to-network relay or 5G ProSe remote UE) desired by the WTRU. The WTRU may send the UL NAS TRANSPORT message carrying the WTRU Policy Container (WTRU Policy Provisioning Request to request WTRU Role specific policies) to the AMF, the AMF relays the UE POLICY PROVISIONING REQUEST message received from the WTRU to the PCF e.g. via invoking Namf_Communication_N1MessageNotify service operation.

The PCF may receive the WTRU Policy Container which indicates WTRU Policy Provisioning Request to request WTRU role specific policies. PCF may evaluate the requested WTRU role specific policies taking into consideration the access technology restrictions in place as per the subscription information stored in the UDM/UDR or inputs from other 5G NFs e.g. AMF/SMF.

The following additional information may be provisioned in the WTRU in support of the WTRU assuming the role of a 5G ProSe UE-to-Network Relay.

A list of the access technologies where the WTRU is authorized to act as 5G ProSe Layer-3 and/or Layer-2 WTRU-to-Network Relay. For example, the WTRU may only be allowed in 4G and 5G terrestrial networks and may not be allowed in non-terrestrial networks (Satellite access for 4G and 5G) to act as a 5G ProSe Layer-3 and/or Layer-2 WTRU-to-Network Relay. The information can be encoded as an byte string or an octet string, wherein byte in the byte string or a bit in the octet string can be used to indicate if an access technology is allowed or not allowed.

In an alternative example, the access technology restrictions may be added to an already provided list of PLMNs in which the WTRU is authorized to relay traffic for 5G ProSe Layer-3 and/or Layer-2 Remote WTRUs. If there are multiple access technologies where the WTRU is authorized for a specific role e.g. WTRU to act as a 5G ProSe Layer-3 and/or Layer-2 WTRU-to-Network Relay, the access technologies may be prioritized, with the first entry being the highest priority.

In another alternative example, access technology restrictions may be indicated by not provisioning the (PC5) radio parameters for the relay discovery and/or communication, when the relay is not served by the NG-RAN access technology. This may mean that the WTRU can act as a relay WTRU only when served by NG-RAN and for all other access technologies the WTRU may not act as a relay WTRU. Furthermore, an additional RAT type parameter (e.g., LTE, NTN) may be provisioned along with the radio parameters in the policy sent to the WTRU. The RAT type may be used to indicate for which RAT the radio parameters may be applied. This may enable the operator to control selectively whether the WTRU may enable relay functionality on a per RAT basis. For example, if radio parameters are provisioned for LTE RAT type but not for NTN then, the WTRU is authorized to act as a relay (i.e., use PC5 radio resources for discovery/communication) when under LTE coverage but not when under NTN coverage. When radio parameters are provided without any RAT type specified the WTRU may act as a relay regardless of the non NG-RAN access it is using, which corresponds to and provides backward compatibility with legacy WTRUs (i.e., that do no support Enhancement to control RAT Utilization feature described herein). It should be noted that such a policy may be provisioned towards the WTRU by the PCF at any time, for example following or part of registration, based on WTRU subscription information, operator policy, an/or WTRU location information.

The following information may be provisioned in the WTRU in support of the WTRU assuming the role of a 5G ProSe Remote WTRU. A list of the access technologies which are allowed/not allowed for the 5G ProSe UE-to-Network Relay to be used (camped on/registered) for providing services to the 5G ProSe Remote WTRU. For example, if the 5G ProSe UE-to-Network Relay is using access technology that is not allowed, the 5G ProSe remote WTRU may not use this particular 5G ProSe UE-to-Network Relay to access network services. The 5G ProSe remote WTRU may try to find another 5G ProSe UE-to-Network Relay which is using an allowed access technology. For example, The 5G ProSe remote WTRU may only be allowed to access 5G ProSe UE-to-Network relay WTRUs which are using 4G/5G terrestrial networks and not using 4G/5G satellite access (non-terrestrial networks). The list of the access technologies may be associated with priority value e.g. 5G access technology is given a higher priority over the 4G access technology.

The provisioning may include an additional flag, which may indicat if the WTRU is required to request updated WTRU role specific policies at every change of access technology i.e. change from 4G to 5G or 5G Terrestrial Network (TN) to 5G non terrestrial network (NTN).

The PCF may use the network-requested WTRU policy management procedure to deliver the new WTRU role specific policies to the requesting WTRU. In order to initiate the network-requested WTRU policy management procedure, the PCF may encode the information about the WTRU Role specific policy and include it in a MANAGE UE POLICY COMMAND message and send it to the requesting WTRU. Upon receipt of the MANAGE UE POLICY COMMAND message the requesting WTRU may store/replace/delete (if new WTRU role specific policy is received empty) the received new WTRU role specific policies. If the policy reception was successful at the WTRU, the WTRU may create MANAGE UE POLICY COMPLETE message and transport the message using the NAS UL Transport message to the PCF/5G NF.

The WTRU may use the WTRU role specific policy information received from the network to enable/disable certain WTRU roles, trigger cell selection/reselection to access technologies to enable certain WTRU roles or even trigger a PLMN search to find a suitable PLMN which can support WTRU desired role.

In a WTRU role specific policy, different configuration may be provided per different RAT/access technology, for example, Layer-2 ID, DRX cycle, etc. Different Layer-2 ID may be utilized by a remote WTRU to differentiate available U2N relay per RAT/access technology in U2N relay selection. Different DRX cycles may be used for 4G RAT, 5G RAT, non- 3GPP RAT, and NTN RAT case. For example, if the WTRU is not allowed to operate as a 5G ProSe UE-to-network relay in the current access technology i.e. NTN access (camped on satellite cell), the WTRU may trigger a cell search to find a cell in an allowed access technology, for example a 4G/5G terrestrial network.

In a scenario where the WTRU is not able to find any suitable cell on the allowed access technology to operate as a 5G ProSe UE-to-network relay, the WTRU may search for a different PLMN with allowed access technology to operate as a 5G ProSe UE-to-network relay.

In a scenario where the WTRU is not able to find any suitable cell on the allowed access technology to operate as a 5G ProSe UE-to-network relay, and the search to find a suitable cell or PLMN is not successful, the WTRU may decide to disable a WTRU role i.e. decide to not operate as a 5G ProSe UE-to-network relay.

In a scenario where the WTRU decides to operate as 5G ProSe remote WTRU, it may try to find 5G ProSe UE-to-network relays which are camped and registered on allowed access technologies. For example, the 5G ProSe remote WTRU may only access the 5G ProSe UE-to-network relay which is using a 4G/5G terrestrial network and not using 4G/5G satellite access (non-terrestrial network). The 5G ProSe UE-to-network relay may indicate its camped access technology to the 5G ProSe remote WTRU during the ProSe direct discovery, Direct Link establishment or ProSe security establishment procedures.

A WTRU which is operating as a 5G ProSe UE-to-network relay during normal operation might encounter situations where the authorization to operate as a 5G ProSe UE-to-network relay WTRU is revoked or not allowed. This revocation may be a result of reception of the new WTRU Role specific policies, or from 5G ProSe UE-to-network relay WTRU selecting/being handed over to a restricted access technology, or operating in an area where it does not have access to an allowed access technology to operate as a 5G ProSe UE-to-network relay WTRU etc.

In these situations where the 5G ProSe UE-to-network relay WTRU cannot operate as a relay WTRU it may inform the remote WTRU's connected to 5G ProSe UE-to-network relay WTRU by initiating a link release procedure and sending direct link release message.

For any new direct link establishment request messages, relay WTRU may reject the link by sending a direct link reject message to the requesting WTRU. The reject/link-release messages may include a new cause code indicating that the link has been released because of the access technology restrictions for the operating 5G ProSe UE-to-network relay WTRU so the remote WTRUs ignore the same 5G ProSe UE-to-network relay WTRU when performing selection/reselection of U2N relay WTRU.

The priority order for the network selection and registration for the PLMN/Access technologies combination may be as follows: either the HPLMN (if the EHPLMN list is not present or is empty) or the highest priority EHPLMN that is available (if the EHPLMN list is present); each PLMN/access technology combination in the “User Controlled PLMN Selector with Access Technology” data file in the SIM (in priority order); each PLMN/access technology combination in the “Operator Controlled PLMN Selector with Access Technology” data file in the SIM (in priority order) or stored in the ME (in priority order); or other PLMN/access technology combinations with received high quality signal in random order.

National roaming services are vital for ensuring seamless connectivity. Allowing unrestricted use of Radio Access Technologies (RAT) for national roamers can result in interoperability issues, quality of service concerns and network congestion concerns.

The current mechanism to limit the WTRUs utilization of certain RAT employed by the network operators involves rejecting the WTRU's attach/TAU request or the registration request with CC #15 or #27 upon the WTRU attempting to attach/register via a specific RAT. However, this existing mechanism results in: higher signaling loads within the network, a service outage until the WTRU selects another RAT, and the WTRU continuing to re-attempt on the same PLMN/RAT upon the WTRU re-enabling the corresponding RAT.

The network operator may restrict a subscriber's access to a certain RAT. For this purpose, the network may send the RAT utilization control information to the WTRU via the NAS signaling messages e.g. Attach/Tracking area update accept. The WTRU may not consider any PLMN and RAT combination with a RAT restriction as a candidate PLMN for PLMN selection, cell selection and cell reselection purposes.

The ProSe UE-to-Network Relay entity provides the functionality to support connectivity to the network for Remote WTRUs as shown in FIG. 3. If the remote WTRU is out of NR coverage and cannot communicate with core network directly (or in NR coverage but prefers to use PC5 for communication), the remote WTRU may discover and select a UE-to-Network relay. Then the remote WTRU may establish a PC5 session with UE-to-Network Relay and the UE-to-Network Relay may establish a PDU session (or PDN connection in EPC) for the remote WTRU. After IP address/prefix allocation, the traffic between remote WTRU and network is relayed by UE-to-Network Relay, as shown FIG. 3.

For 5G ProSe UE-to-Network Relay discovery, both Model A and Model B discovery are supported. Model A uses a single discovery protocol message (Announcement), and Model B uses two discovery protocol messages (Solicitation and Response). For Relay Discovery Additional Information, only Model A discovery is used.

For 5G ProSe WTRU-to-NW Relay, the layer-2 link procedures over PC 5 reference point for unicast mode 5G ProSe Direct Communication should perform as between the Remote WTRU and U2N Relay WTRU. The layer-2 link procedures include L2 link establishment over PC5, Link ID update for a unicast link, L2 link release over PC5 reference point, L2 link modification for a unicast link, and L2link maintenance over PC5 reference point (keep alive procedure).

After being connected to the 5G ProSe UE-to-Network Relay, the 5G ProSe Remote WTRU may keep performing a measurement of the signal strength of PC 5 unicast link with the 5G ProSe UE-to-Network Relay for relay reselection. For a relay reselection procedure, the 5G ProSe UE-to-Network Relay discovery procedures may be used to discover available 5G ProSe UE-to-Network Relays for 5G ProSe UE-to-Network Relay reselection.

Procedures for U2N Relay to provide access to emergency services to Remote WTRUs may be specified. The Relay is configured with an RSC associated with a DNN dedicated for emergency services. The relay WTRU provides a PDU Session to a Remote WTRU that request to connect using the RSC. The Relay may use the PDU Session for its own emergency call needs.

A mobile operator, in order to provide better user experience, should be able to control the authorization for the relay WTRU based on the access network it's using to access the network i.e., terrestrial vs satellite access. The foregoing description is related to solutions to ensure that the mobile network operator have control in authorizing the WTRUs to perform certain services or use capabilities or WTRU Roles (e.g., act as a relay WTRU, Vehicle Mounted relay (VMR), UAV etc.) based on the access technology being used by the WTRU to access the network.

The technological solutions enable the mobile network operator to have control in authorizing WTRUs to perform certain services or enable use of certain capabilities or perform certain WTRU Roles (e.g., act as a relay WTRU, Vehicle Mounted relay (VMR), UAV etc.) based on the access technology being used by the WTRU to access the network. The solutions include an update to the WTRU policy provisioning procedure, wherein new information elements are defined specific to WTRU Roles (e.g., 5G ProSe UE-to-network relay or 5G ProSe remote UE) delivered to the WTRU via network requested WTRU policy management procedure. These new policies may determine if the WTRU is allowed/not allowed to operate in certain WTRU roles based on the access technology being used by the WTRU to access the 5G network. Furthermore, this new policy reception at the WTRU may trigger updates to the PLMN search, cell selection and reselection logic to ensure that WTRU behaves in certain WTRU roles (e.g., 5G ProSe UE-to-network relay or 5G ProSe remote UE) as desired by the user of the WTRU. The policy update and usage may in the WTRU not being authorized to perform a certain role. For example, the relay WTRU, due to handover to a restricted access technology, being no longer authorized to operate as a relay WTRU, may result in rejection/link release message being sent to the remote WTRU's which were either connected or trying to connect to the relay WTRU.

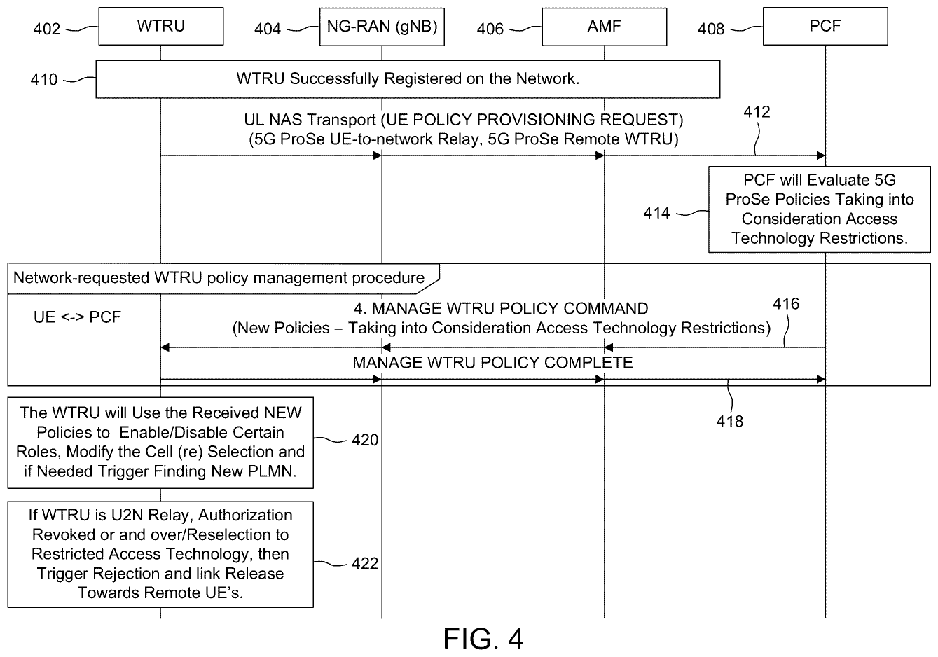

FIG. 4 illustrates an example WTRU requested WTRU Role specific policy provisioning procedure.

WTRU 402 successfully registers with the wireless network, for example a 5G wireless network at 410. The WTRU 402 may take up the role of a 5G ProSe UE-to-network relay or 5G ProSe remote WTRU, and WTRU 402 may need to be configured with the necessary configuration and policies by the network to be able to operate in the desired role.

At 412, a request for a WTRU Role specific policy provisioning procedure is initiated by WTRU 402 to request a WTRU Role Policy/Parameter from PCF 408 under following conditions: WTRU 402 does not have any valid WTRU Role Specific policies. (Initial registration/power up scenario, WTRU Role has been enabled by the higher lawyers etc.), or the WTRU Role policies have a parameter indicating that at every change of access technology, WTRU 402 should request new set of policies from the 5GS (e.g. PCF).

In order to initiate the WTRU requested WTRU Role specific policy provisioning procedure, WTRU 402 may create a UE POLICY PROVISIONING REQUEST message, including the requested WTRU role specific policies (e.g., 5G ProSe UE-to-network relay or 5G ProSe remote UE) desired by WTRU 402. At 412, WTRU 402 sends the UL NAS TRANSPORT message carrying the WTRU Policy Container (UE Policy Provisioning Request to request WTRU Role specific policies) to AMF 406 via gNB 404, and AMF 406 relays the UE POLICY PROVISIONING REQUEST message received from WTRU 402 to PCF 418 e.g. via invoking Namf_Communication_N1MessageNotify service operation.

PCF 408 receives the WTRU Policy Container which indicates WTRU Policy Provisioning Request to request role specific policies for WTRU 402 at 412. PCF 408, at 414, may evaluate the requested WTRU role specific policies taking into consideration the access technology restrictions in place as per the subscription information stored in the UDM/UDR or inputs from other 5G NFs e.g. AMF/SMF.

The following additional information may be provisioned in WTRU 402 in support of WTRU 402 assuming the role of a 5G ProSe UE-to-Network Relay. A list of the access technologies where the WTRU is authorized to act as 5G ProSe Layer-3 and/or a Layer-2 UE-to-Network Relay. For example, the WTRU may only be allowed in 4G and 5G terrestrial networks and may not be allowed in non-terrestrial networks (Satellite access for 4G and 5G) to act as a 5G ProSe Layer-3 and/or Layer-2 UE-to-Network Relay. The information can be encoded as an byte string or an octet string, wherein byte in the byte string or a bit in the octet string can be used to indicate if an access technology is allowed or not allowed.

Alternatively the access technology restrictions may be added to an already provided list of PLMNs in which the WTRU is authorized to relay traffic for 5G ProSe Layer-3 and/or Layer-2 Remote WTRUs. If there are multiple access technologies where the WTRU is authorized for a specific role e.g. WTRU to act as a 5G ProSe Layer-3 and/or Layer-2 UE-to-Network Relay, the access technologies may be prioritized, with the first entry being the highest priority.

In another alternative, access technology restrictions can be indicated by not provisioning the (PC5) radio parameters for the relay discovery and/or communication, when the relay is not served by the NG-RAN access technology. This may mean that the WTRU can act as a relay WTRU only when served by NG-RAN and for all other access technologies the WTRU cannot act as a relay WTRU. Furthermore, an additional RAT type parameter (e.g., LTE, NTN) may be provisioned along with the radio parameters in the policy sent to the WTRU. The RAT type may be used to indicate for which RAT the radio parameters can be applied. This may enable the operator to control selectively whether the WTRU can enable relay functionality on a per RAT basis. For example, if radio parameters are provisioned for LTE RAT type but not for NTN then, the WTRU is authorized to act as a relay (i.e., use PC5 radio resources for discovery/communication) when under LTE coverage but not when under NTN coverage. When radio parameters are provided without any RAT type specified the WTRU can act as a relay regardless of the non NG-RAN access it is using, which corresponds to and provides backward compatibility with legacy WTRUs (i.e., that do no support Enhancement to control RAT Utilization feature described herein). It should be noted that such policy may be provisioned towards the WTRU by the PCF at any time (e.g., following or part of registration at 412 based on WTRU subscription information, operator policy, or WTRU location information.

The following information may be provisioned in the WTRU in support of the WTRU assuming the role of a 5G ProSe Remote WTRU. A list of the access technologies which are allowed/not allowed for the 5G ProSe UE-to-Network Relay to be used (camped on/registered) for providing services to the 5G ProSe Remote WTRU. For example, if the 5G ProSe UE-to-Network Relay is using access technology not allowed, the 5G ProSe remote WTRU may not use this particular 5G ProSe UE-to-Network Relay to access network services. The 5G ProSe remote WTRU may try to find another 5G ProSe UE-to-Network Relay which is using an allowed access technology. For example, The 5G ProSe remote WTRU is only allowed to access 5G ProSe UE-to-Network relay WTRUs which are using 4G/5G terrestrial networks and not using 4G/5G satellite access (non-terrestrial networks). The list of the access technologies may be associated with priority value e.g. 5G access technology is given a higher priority over the 4G access technology.

The information may include an additional flag, which indicates if the WTRU needs to request updated WTRU role specific policies at every change of access technology i.e. change from 4G to 5G or 5G Terrestrial Network (TN) to 5G non terrestrial network (NTN). PCF 410 may use the network-requested WTRU policy management procedure to deliver the new WTRU role specific policies to the requesting WTRU.

PCF 408 may encode the information about the WTRU Role specific policy and include it in a MANAGE UE POLICY COMMAND message and send it to WTRU 402 at 416. Upon receipt of the MANAGE UE POLICY COMMAND message WTRU 402 may store/replace/delete (if new WTRU role specific policy is received empty) the new WTRU role specific policies received. If the policy reception was successful, WTRU 402 may create MANAGE UE POLICY COMPLETE message and at 418 transport the message using the NAS UL Transport message to the PCF 408.

At 420, WTRU 402 may use the WTRU role specific policy information received from the network to enable/disable certain WTRU roles, trigger cell selection/reselection to access technologies to enable certain WTRU roles and may trigger a PLMN search to find a suitable PLMN which can support WTRU desired role.

In the WTRU role specific policy, different configuration may be provided per different RAT/access technology. for example, Layer-2 ID, DRX cycle, etc. Different Layer-2 ID may be utilized by a Remote WTRU to differentiate available U2N relay per RAT/access technology in U2N relay selection. Different DRX cycles may be used for 4G RAT, 5G RAT, non3GPP RAT, and NTN RAT case. For example, if the WTRU is not allowed to operate as a 5G ProSe UE-to-network relay in the current access technology i.e. NTN access (camped on satellite cell), the WTRU may trigger cell search to find a cell in allowed access technology i.e. 4G/5G terrestrial network.

In a case where the WTRU is not able to find any suitable cell on the allowed access technology to operate as a 5G ProSe UE-to-network relay, the WTRU might search for a different PLMN with allowed access technology to operate as a 5G ProSe UE-to-network relay.

In a case where the WTRU is not able to find any suitable cell on the allowed access technology to operate as a 5G ProSe UE-to-network relay, the WTRU may search to find a suitable cell or PLMN, and if not successful, the WTRU may decide to disable a WTRU role i.e. decide to not operate as a 5G ProSe UE-to-network relay.

In a case where the WTRU decides to operate as 5G ProSe remote WTRU, it may try to find 5G ProSe UE-to-network relays which are camped and registered on allowed access technologies. For example, the 5G ProSe remote WTRU may only access a 5G ProSe UE-to-network relay that is using a 4G/5G terrestrial network and not using 4G/5G satellite access (non-terrestrial network). The 5G ProSe UE-to-network relay may indicate it is camped access technology to the 5G ProSe remote WTRU during the ProSe direct discovery, Direct Link establishment, or ProSe security establishment procedures.

At 422, WTRU 402, operating as 5G ProSe UE-to-network relay during the normal operation might encounter situations where the authorization to operate as a 5G ProSe UE-to-network relay WTRU is revoked or not allowed. This revocation can be a result of a reception of the new WTRU Role specific policies, or from 5G ProSe UE-to-network relay WTRU selecting/being handed over to a restricted access technology, or operating in an area where it does not have access to an allowed access technology to operate as a 5G ProSe UE-to-network relay WTRU etc.

In these situations where the 5G ProSe UE-to-network relay WTRU cannot operate as a relay WTRU it may inform remote WTRU's connected to a 5G ProSe UE-to-network relay WTRU by initiating the link release procedure and sending direct link release message. The link release message may include a cause code that indicates that the WTRU is not authorized to act as a 5G ProSe UE-to-network relay while connected to a RAT that the WTRU is currently connected to.

For any new direct link establishment request messages, it may reject the link by sending a direct link reject message to the requesting WTRU. The reject/link-release messages could include a new cause code indicating that the link has been released because of the access technology restrictions for the operating 5G ProSe UE-to-network relay WTRU so the remote WTRUs ignore the same 5G ProSe UE-to-network relay WTRU when performing selection/reselection of U2N relay WTRU.

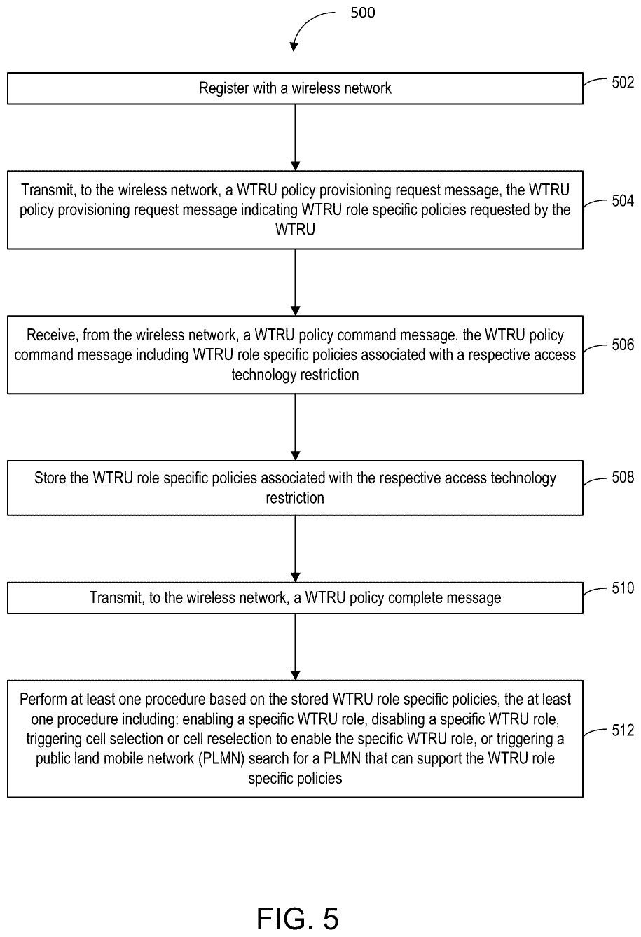

FIG. 5 is a flow diagram of an example WTRU Role specific policy provisioning process. In some implementations, one or more process blacks may be performed by a WTRU.

As shown in FIG. 5, process 500 may include registering with a wireless network at 502. For example, a WTRU may register with a wireless network, as described above. As also shown in FIG. 5, process 500 may include, at 504, transmitting, to the wireless network, a WTRU policy provisioning request message, the WTRU policy provisioning request message indicating WTRU role specific policies requested by the WTRU. For example, the WTRU may transmit, to the wireless network, a WTRU policy provisioning request message, the WTRU policy provisioning request message indicating WTRU role specific policies requested by the WTRU, as described above. As further shown in FIG. 5, process 500 may include, at 506, receiving, from the wireless network, a WTRU policy command message, the WTRU policy command message including WTRU role specific policies associated with a respective access technology restriction). For example, the WTRU may receive, from the wireless network, a WTRU policy command message, the WTRU policy command message including WTRU role specific policies associated with a respective access technology restriction, as described above. As also shown in FIG. 5, process 500 may include, at 508, storing the WTRU role specific policies associated with the respective access technology restriction. For example, WTRU may store the WTRU role specific policies associated with the respective access technology restriction, as described above. As further shown in FIG. 5, process 500 may include, at 510, transmitting, to the wireless network, a WTRU policy complete message. For example, the WTRU may transmit, to the wireless network, a WTRU policy complete message, as described above. As also shown in FIG. 5, process 500 may include, at 512, performing at least one procedure based on the stored WTRU role specific policies, the at least one procedure including: enabling a specific WTRU role, disabling a specific WTRU role, triggering cell selection or cell reselection to enable the specific WTRU role, or triggering a public land mobile network (PLMN) search for a PLMN that can support the WTRU role specific policies. For example, the WTRU may perform at least one procedure based on the stored WTRU role specific policies, the at least one procedure including: enabling a specific WTRU role, disabling a specific WTRU role, triggering cell selection or cell reselection to enable the specific WTRU role, or triggering a public land mobile network (PLMN) search for a PLMN that can support the WTRU role specific policies, as described above.

Process 500 may include additional implementations, such as any single implementation or any combination of implementations described below and/or in connection with one or more other processes described elsewhere herein. In a first implementation, the WTRU specific role is one of operating as a WTRU-to-network relay or operating as a remote WTRU.

A second implementation, alone or in combination with the first implementation, process 500 may further include transmitting the WTRU policy provisioning request each time an access technology currently employed by a serving cell is changed, or transmitting the WTRU policy provisioning request in a case where no WTRU role specific policies are currently stored by the WTRU.

In a third implementation, alone or in combination with the first and second implementation, the WTRU specific role is operating as the WTRU-to-network relay and where the WTRU role specific policies include a list of access technologies where the WTRU is authorized to act as a ProSe layer-3 WTRU-to-network relay or a ProSe layer-2 WTRU-to-network relay.

In a fourth implementation, alone or in combination with one or more of the first through third implementations, triggering cell reselection is performed when the WTRU operating as the WTRU-to-network relay is not authorized to operate as the WTRU-to-network relay in an access technology currently employed by a serving cell.

In a fifth implementation, alone or in combination with one or more of the first through fourth implementations, process 500 may further include searching for a new PLMN when the WTRU operating as the WTRU-to-network relay cannot find a cell where the WTRU is authorized to operate as a WTRU-to-network relay, where access technology restrictions are added to an existing list of PLMNs in which the WTRU operating as the WTRU-to-network relay is authorized to operate as the WTRU-to-network relay.

A sixth implementation, alone or in combination with one or more of the first through fifth implementations, process 500 may further include initiating a link release procedure to inform a remote WTRU that an authorization to operate as the WTRU-to-network relay is revoked or not allowed.

In a seventh implementation, alone or in combination with one or more of the first through sixth implementations, the WTRU specific role is to operate as the remote WTRU and the WTRU role specific policies include: a list of access technologies where one or more WTRU-to-network relays are authorized and a list of access technologies where one or more WTRU-to-network relays are not authorized, either alone or in combination, and where the list of access technologies where one or more WTRU-to-network relays are authorized includes a respective priority for each of the one or more WTRU-to-network relays that are authorized.

An eighth implementation, alone or in combination with one or more of the first through seventh implementations, process 500 may include selecting a relay WTRU based on the list access technologies where the one or more WTRU-to-network relays are authorized.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method performed in a wireless transmit/receive unit (WTRU), the method comprising:
registering with a wireless network;
transmitting, to the wireless network, a WTRU policy provisioning request message, the WTRU policy provisioning request message indicating WTRU role specific policies requested by the WTRU;
receiving, from the wireless network, a WTRU policy command message, the WTRU policy command message including WTRU role specific policies associated with a respective access technology restriction;
storing the WTRU role specific policies associated with the respective access technology restriction;
transmitting, to the wireless network, a WTRU policy complete message; and
performing at least one procedure based on the stored WTRU role specific policies, the at least one procedure including: enabling a specific WTRU role, disabling a specific WTRU role, triggering cell selection or cell reselection to enable the specific WTRU role, or triggering a public land mobile network (PLMN) search for a PLMN that can support the WTRU role specific policies;.

2. The method of claim 1, wherein the WTRU specific role is one of operating as a WTRU-to-network relay or operating as a remote WTRU.

3. The method of claim 2, further comprising: transmitting the WTRU policy provisioning request each time an access technology currently employed by a serving cell is changed, or transmitting the WTRU policy provisioning request in a case where no WTRU role specific policies are currently stored by the WTRU.

4. The method of claim 2, wherein the WTRU specific role is operating as the WTRU-to-network relay and wherein the WTRU role specific policies include a list of access technologies where the WTRU is authorized to act as a ProSe layer-3 WTRU-to-network relay or a ProSe layer-2 WTRU-to-network relay.

5. The method of claim 4, wherein triggering cell reselection is performed when the WTRU operating as the WTRU-to-network relay is not authorized to operate as the WTRU-to-network relay in an access technology currently employed by a serving cell.

6. The method of claim 5, further comprising: searching for a new PLMN when the WTRU operating as the WTRU-to-network relay cannot find a cell where the WTRU is authorized to operate as a WTRU-to-network relay, wherein access technology restrictions are added to an existing list of PLMNs in which the WTRU operating as the WTRU-to-network relay is authorized to operate as the WTRU-to-network relay.

7. The method of claim 6, further comprising: initiating a link release procedure to inform a remote WTRU that an authorization to operate as the WTRU-to-network relay is revoked or not allowed.

8. The method of claim 2, wherein the WTRU specific role is to operate as the remote WTRU and the WTRU role specific policies include: a list of access technologies where one or more WTRU-to-network relays are authorized and a list of access technologies where one or more WTRU-to-network relays are not authorized, either alone or in combination, and wherein the list of access technologies where one or more WTRU-to-network relays are authorized includes a respective priority for each of the one or more WTRU-to-network relays that are authorized.

9. The method of claim 8, further comprising selecting a relay WTRU based on the list access technologies where the one or more WTRU-to-network relays are authorized.

10. A wireless transmit/receive unit (WTRU) comprising:
processor circuitry; and
a transceiver coupled to the processor circuitry and configured to:
transmit, to a wireless network, a WTRU policy provisioning request message, the WTRU policy provisioning request message indicating WTRU role specific policies requested by the WTRU, wherein the WTRU is registered with the wireless network; and
receive, from the wireless network, a WTRU policy command message, the WTRU policy command message including WTRU role specific policies associated with a respective access technology restriction;
the processor circuitry configured to store the WTRU role specific policies associated with the respective access technology restriction;
the transceiver configured to transmit, to the wireless network, a WTRU policy complete message; and
the processor circuitry configured to perform at least one procedure to perform based on the stored WTRU role specific policies, the at least one procedure including: enabling a specific WTRU role, disabling a specific WTRU role, triggering cell selection or cell reselection to enable the specific WTRU role, or triggering a public land mobile network (PLMN) search for a PLMN that can support the WTRU role specific policies.

11. The WTRU of claim 10, wherein the WTRU specific role is one of operating as a WTRU-to-network relay or operating as a remote WTRU.

12. The WTRU of claim 11, wherein the transceiver is further configured to transmit the WTRU policy provisioning request each time an access technology currently employed by a serving cell is changed, or transmitting the WTRU policy provisioning request in a case where no WTRU role specific policies are currently stored by the WTRU.

13. The WTRU of claim 11, wherein the WTRU specific role is operating as the WTRU-to-network relay and wherein the WTRU role specific policies include a list of access technologies where the WTRU is authorized to act as a ProSe layer-3 WTRU-to-network relay or a ProSe layer-2 WTRU-to-network relay.

14. The WTRU of claim 13, wherein the processor circuitry is configured to trigger cell reselection when the WTRU operating as the WTRU-to-network relay is not authorized to operate as the WTRU-to-network relay in an access technology currently employed by a serving cell.

15. The WTRU of claim 14, wherein the transceiver is further configured to search for a new PLMN when the WTRU operating as the WTRU-to-network relay cannot find a cell where the WTRU is authorized to operate as a WTRU-to-network relay, wherein access technology restrictions are added to an existing list of PLMNs in which the WTRU operating as the WTRU-to-network relay is authorized to operate as the WTRU-to-network relay.

16. The WTRU of claim 15, wherein the transceiver is further configured to initiate a link release procedure to inform a remote WTRU that an authorization to operate as the WTRU-to-network relay is revoked or not allowed.

17. The WTRU of claim 11, wherein the WTRU specific role is to operate as the remote WTRU and the WTRU role specific policies include: a list of access technologies where one or more WTRU-to-network relays are authorized and a list of access technologies where one or more WTRU-to-network relays are not authorized, either alone or in combination, and wherein the list of access technologies where one or more WTRU-to-network relays are authorized includes a respective priority for each of the one or more WTRU-to-network relays that are authorized.

18. The WTRU of claim 17, wherein the processor circuitry is further configured to select a relay WTRU based on the list access technologies where the one or more WTRU-to-network relays are authorized.
